(19) United States
(12) Patent Application Publication
(10) Pub. No.: US 2003/0095026 A1
(43) Pub. Date: May 22, 2003

(54) Transformer

(75) Inventor: Kazuo Kawanobe, Osaka (JP)

Correspondence Address: ARMSTRONG,WESTERMAN & HATTORI, LLP, 1725 K STREET, NW, SUITE 1000, WASHINGTON, DC, 20006, US

(73) Assignee: JHC OSAKA CORPORATION, Osaka (JP)

(21) Appl. No.: 10/170,502

(22) Filed: Jun. 14, 2002

(30) Foreign Application Priority Data
Nov. 21, 2001 (JP) 2001-355822

(51) Int. Cl. H01F 5/00

(52) U.S. Cl. 336/200

(57) ABSTRACT

A transformer made of a multilayer construction in which plural spiral primary-side coils of thin plate and plural spiral secondary-side coils of thin plate are layered in turn. The primary-side coils of the multilayer construction are connected each other, the secondary-side coils of the multilayer construction are connected each other, an upper shielding layer of thin plate is disposed on the uppermost layer of the multilayer construction, and a lower shielding layer is disposed under the lowermost layer of the multilayer construction.

### BACKGROUND OF THE INVENTION

1. Field of the Invention

This invention relates to a transformer used for various electronic appliances.

2. Description of the Related Art

A transformer is, for example, used for an AC adaptor. Generally, a portable electronic appliance, including a secondary battery, gains necessary direct current from a commercial power source through the AC adaptor as an outside power supplier to charge the secondary battery and drive the main body.

Generally, an AC adaptor provided with a transformer may have various box-type configurations of which size varies according to required electric power, and switching regulator method is exclusively used to compose the electric circuit of the adaptor for efficiency in electric power-transformation. In this method, a large toroidal coil, to separate and insulate the output circuit from the commercial power source, and, several kinds of coils for energy accumulation to function as the switching regulator, are used.

Although the switching regulator method occupies the mainstream of means to realize an AC adaptor of high efficiency and small size in current electronic technology, making a thin case body of the adaptor has to be restricted by the coil having a toroidal core and the coils of several other kinds as indispensable components for the circuit.

Generally, in the AC adaptor of the switching regulator method, thickness of the case body becomes unavoidably large for the physical configurations of the used parts, the configuration of the case body has to be box-type to minimize the volume, and inconvenience or inadequacy may be caused when the adaptor is carried with a portable appliance.

In view of the above situation, the present invention, for example, a transformer assembled into an AC adaptor used for portable and other types of electronic appliances, is to provide a transformer having a small and flat coil instead of the coil with the toroidal core which governs the thickness of the appliance, and able to provide necessary performance with an extremely thin form.

### BRIEF DESCRIPTION OF THE DRAWINGS

The present invention will be described with reference to the accompanying drawings in which:

FIG. 1 is a top view showing an embodiment of a primary-side coil of the present invention;

FIG. 2 is a top view showing an embodiment of a secondary-side coil of the present invention;

FIG. 3 is a top view showing an embodiment of a shielding layer of the present invention;

FIG. 4 is a cross-sectional side view of a transformer;

FIG. 5 is an explanatory view showing through hole terminal portions;

FIG. 6 is an explanatory view showing through hole portions for shielding of the coil;

FIG. 7 is an explanatory view showing through hole portions for shielding of the shielding layer;

FIG. 8 is a concrete circuit diagram in which the transformer of the present invention is used;

FIG. 9 is an explanatory view showing wave forms of respective portions in the circuit of FIG. 8;

FIG. 10 is another concrete circuit diagram; and

FIG. 11 is an explanatory view showing wave forms of respective portions in the circuit of FIG. 10.

### DESCRIPTION OF THE PREFERRED EMBODIMENTS

The present invention, for example, relates to a transformer assembled into an AC adaptor as a form of a power source to obtain direct current from a commercial power source. Although this AC adaptor may have different internal constructions according to its purposes, switching regulator method is used in most cases in which large amount of electric power is handled with a small-sized and light-weight adaptor. With this method, although the adaptor can be small-sized and light-weight for very high efficiency in electric power transformation, a case body of the adaptor is restricted to being thin for physical disposition of coils with toroidal core to compose the circuit. The present invention establishes an art which can provide a very thin AC adaptor, although having a slight reduction of the efficiency in electric power transformation, by realizing a high-frequency coil functioning in place of the coil with toroidal core as a key component.

To describe concretely, electric power from a commercial power source of 50 Hz or 60 Hz is preliminary transformed into high-frequency alternate current, and then, the voltage is transformed by a super-flat high-frequency transformer having a predetermined construction at a high-frequency level. In this high-frequency transformer, a primary side, directly connected to the commercial power source, and a secondary side, connected to an appliance, are entirely separated and insulated dynamically.

This high-frequency transformer has a super-flat coil composed of a multilayer substrate construction for its characteristics dealing with high frequency. And, in the high-frequency transformer, shielding layers to shield excessive electromagnetism radiated outward is provided, and ferrite material, having good high-frequency characteristics and small magnetism loss, is painted or vapor-depositioned on an upper and a lower surface of the shielding layer and inner parts of through holes as shielding portion disposed on a peripheral portion and a central portion of the transformer to enhance total efficiency of electricity transmission together with magnetism shielding ability.

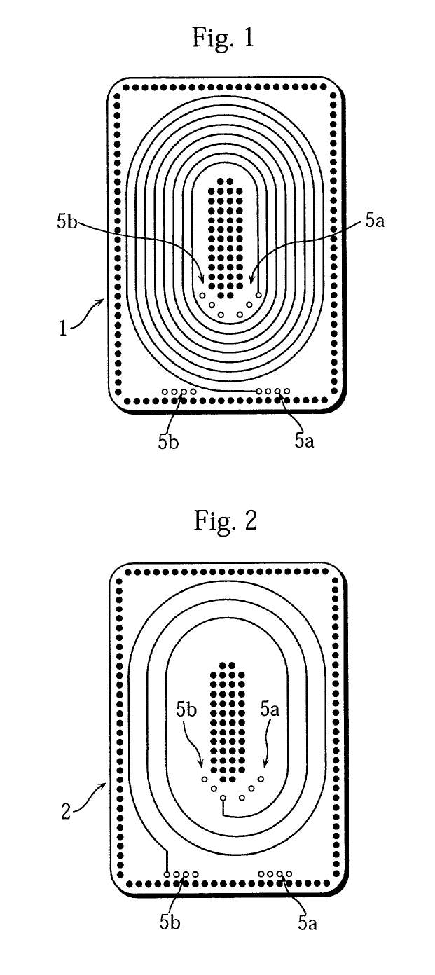

FIG. 1 is a top view (construction view of each part) of a super-low-profile high-frequency coil forms a main portion in an embodiment of the present invention. FIG. 1 shows a pattern used as a primary-side coil 1. Three primary-side coils are used in the present embodiment.

FIG. 2 shows a pattern used as a secondary-side coil 2. Three secondary-side coils are used in the present embodiment.

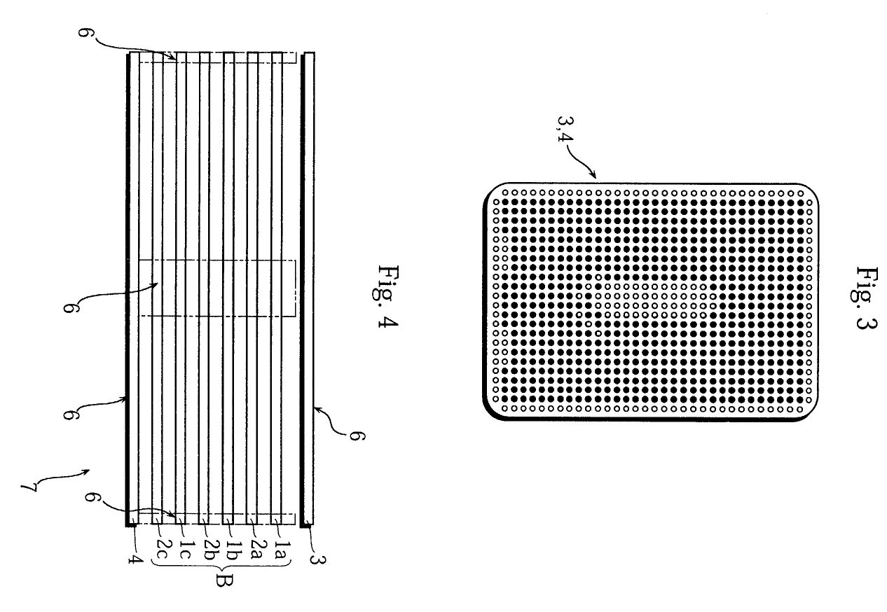

FIG. 3 is a top view of an upper shielding layer 3 and a lower shielding layer 4 respectively disposed on the upper and the lower side of the transformer in the present embodiment.

In the present embodiment, as shown in FIG. 4, three primary-side coils 1a, 1b, and 1c, and three secondary-side coils 2a, 2b, and 2c are disposed as to be layered in turn to form a multilayer construction B, and the upper shielding layer (upper shielding plate) 3 is disposed on an upper position and the lower shielding layer (lower shielding plate) 4 is disposed on a lower position in the multilayer construction to compose a high-frequency coil 7 of a eight-layer substrate construction.

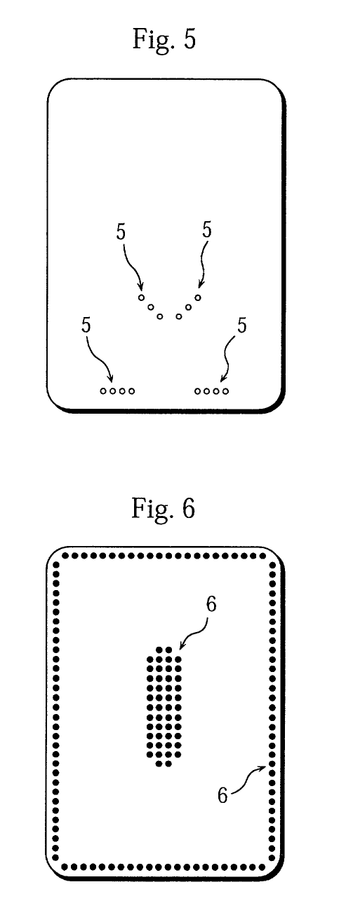

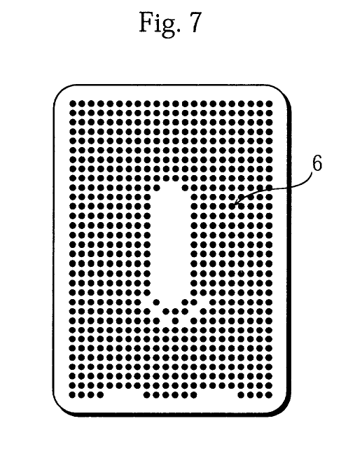

FIG. 5 shows through hole terminal portions 5 to connect (conduct) the coils of each layer (the shielding layers 3 and 4) through the whole layers from the upper shielding layer 3 to the lower shielding layer 4, FIG. 6 shows through hole portions 6 for shielding through the whole layers of the multilayer construction B, and FIG. 7 shows the through hole portions 6 for shielding (patterned portion for shielding) of the upper shielding layer 3 and the lower shielding layer 4 on the uppermost layer and the lowermost layer of the high-frequency coil 7. In FIGS. 5 through 7, many independent circular patterns unconnected each other are disposed as eddy current generated on individual circular patterns do not confluent each other.

FIG. 4 is a cross-sectional side view of the eight-layer substrate construction as the present embodiment composed of a first layer as the shielding layer (the upper shielding layer 3), a second layer as the primary-side coil layer 1a, a third layer as the secondary-side coil layer 2a, a fourth layer as the primary-side coil layer 1b, a fifth layer as the secondary-side coil layer 2b, a sixth layer as the primary-side coil layer 1c, a seventh layer as the secondary-side coil layer 2c, and a eighth layer as the lowermost layer (the lower shielding layer 4). The first layer as the shielding layer (the upper shielding layer 3), the eighth layer as the shielding layer (the lower shielding layer 4), and the shielding through hole portions 6 on the periphery and the central portion of the multilayer construction B on which ferrite material is disposed (painted or vapor-depositioned) are shown in black. That is to say, the ferrite material is disposed on these through holes to make the shielding through hole portions 6, and the parts on which the ferrite material is painted or vapor-depositioned form an EI core construction in which an E core and an I core are combined, namely, a complete electromagnetism confining construction.

To describe further in detail, in the transformer of the present invention, the spiral primary-side coil 1 of thin plate composed of a printed pattern and the spiral secondary-side coil 2 of thin plate composed of a printed pattern are layered in turn to form the multilayer construction B. And, the primary-side coils 1a, 1b, and 1c are connected (electrically conducted) each other by insertion of conducting pins to the through hole terminal portions 5, the secondary-side coils 2a, 2b, and 2c are connected (electrically conducted) each other by insertion of conducting pins to the through hole terminal portions 5, and the upper shielding layer 3 of thin plate and the lower shielding layer 4 of thin plate are respectively disposed as the uppermost layer and the lowermost layer of the multilayer construction B. The primary-side coils and the secondary-side coils can be connected as described above with the conducting pins because the end portion of the spiral coil as the primary-side coil 1 in FIG. 1 is connected to a right through hole terminal portion 5a, and the end portion of the spiral coil as the secondary-side coil 2 in FIG. 2 is connected to a left through hole terminal portion 5b.

To describe the shielding through hole portion 6 further, the ferrite material having good high-frequency characteristics and small magnetic loss is disposed on the surface of the upper shielding layer 3, the surface of the lower shielding layer 4, a peripheral side portion of the multilayer construction B (namely, a peripheral side portion of the high-frequency coil 7), and inner peripheral portions (central portions) of the primary-side coils 1 and the secondary-side coils 2. The transformer has a construction to confine the generated magnetic field more strictly to enhance total efficiency in electric power transmission with the ferrite material painted or vapor-depositioned on these portions.

With the construction above, the uppermost and lowermost layers, the peripheral portion of the high-frequency coil 7, and the central portions of the spiral coils are perfectly connected with the shielding through hole portions 6 (the through holes on which the ferrite material is disposed), each of the primary-side coils 1 and the secondary-side coils 2 is wrapped to shield high-frequency electric field. Therefore, the high-frequency transformer can efficiently transmit the electric power transformed into high-frequency.

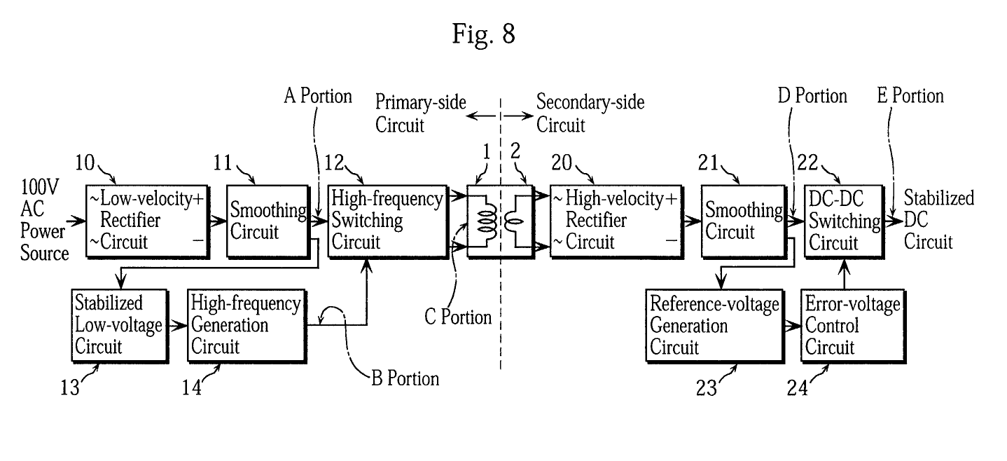

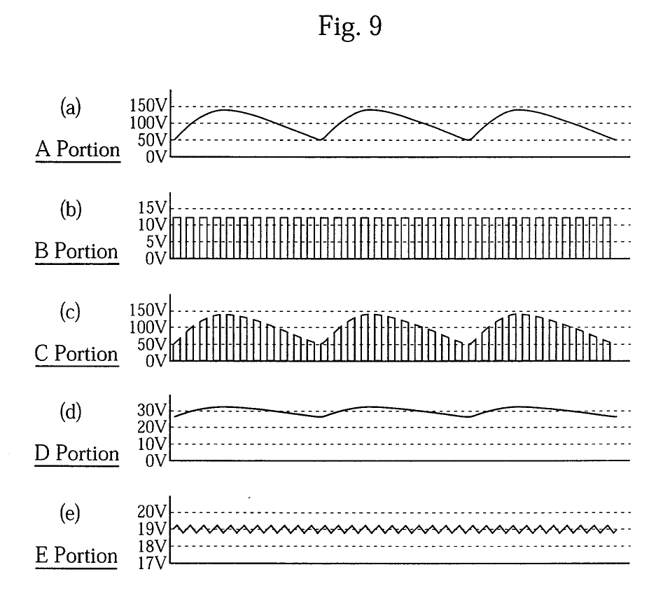

FIG. 8 is a concrete circuit diagram in which the super-low-profile high-frequency coil of the present invention is used. Commercial AC power is rectified through a low-velocity rectifier circuit 10 and transformed into direct current including ripples through a smoothing circuit 11. This is shown with a wave form A of (a) in FIG. 9. A high-frequency generation circuit 14 driven by a stabilized low-voltage circuit 13 generates regular high frequency. This is shown with a wave form B of (b) in FIG. 9. This output is driving a high-frequency switching circuit 12 and given to the primary-side coil 1 of the super-low-profile high-frequency coil as a high-frequency signal modulated by the wave form A as shown with a wave form C of (c) in FIG. 9. The primary-side coil 1 of the super-low-profile high-frequency coil is circuitally processed as to resonant with the switching drive high-frequency under the service condition.

In the secondary-side coil 2 tightly connected to the primary-side coil 1 of the super-low-profile high-frequency coil, decreased high-frequency voltage, determined by winding ratio of the primary and secondary coils, is generated. This is detected and rectified by a high-velocity rectifier circuit 20 and smoothed by a smoothing circuit 21 to obtain low-voltage direct current including ripples shown with a wave form D of (d) in FIG. 9. Required stabilized DC output is obtained from the DC power through a DC-DC switching regulator circuit composed of a DC-DC switching circuit 22, a reference-voltage generation circuit 23, and an error-voltage control circuit 24. Several ripples caused by comparative error are included in the stabilized output as shown with a wave form E of (e) in FIG. 9.

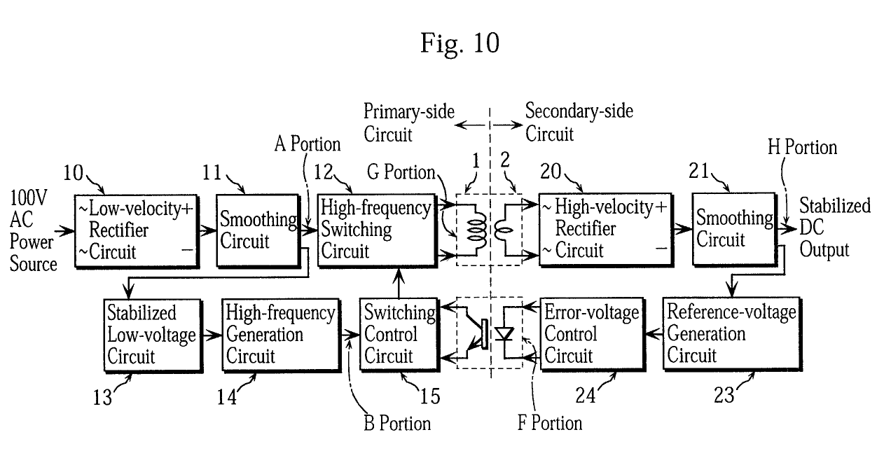

FIG. 10 is a concrete circuit diagram in which the super-low-profile high-frequency coil of the present invention is used. Although basic construction of the circuit is similar to that of FIG. 8, the control method of the DC-DC switching regulator circuit is changed as that a photo coupler composed of a photo diode 25 and a photo transistor 16 removes primary and secondary isolation, signal of the error-voltage control circuit is lead to the switching control circuit 15 on the primary side, and the high-frequency switching circuit 12 itself is directly controlled to stabilize the DC output voltage on the secondary side.

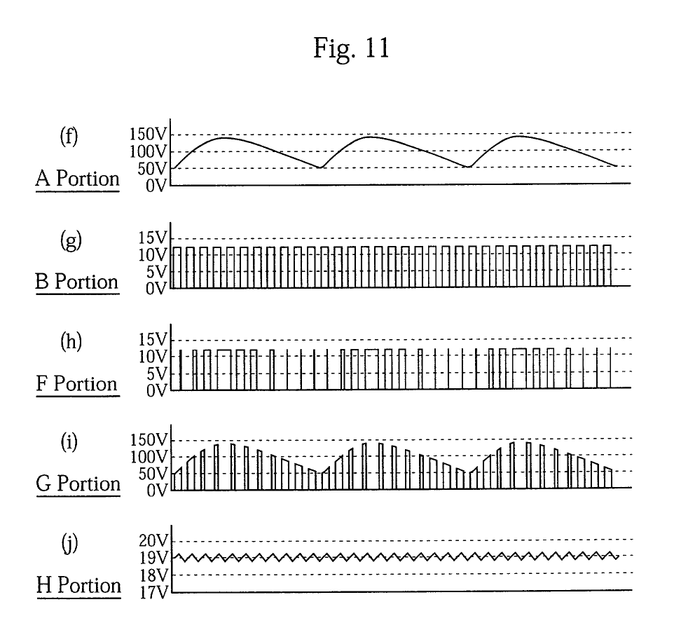

The output wave form of the error-voltage control circuit 24 is as shown with a wave form F of (h) in FIG. 11. And, the working wave form of the high-frequency switching circuit 12 in the present method, as shown with a wave form G of (i) in FIG. 11, follows the state of the primary-side modulation voltage and the variance of the secondary-side output power, and changes the high-frequency electric energy sent to the primary-side coil 1 to obtain the required stability of the secondary-side output. However, in the present method, as a wave form H of (i) in FIG. 11, remaining ripples caused by control time response of the circuit may be worse than that of the circuit composition of FIG. 8.

According to the transformer of the present invention, realizing the super-low-profile high-frequency coil functioning instead of the coil with a toroidal core, an extremely thin transformer, although the efficiency of electric power transform is slightly lowered, can be composed to provide, for example, a small adaptor.

And, generated magnetic field is strictly confined further to enhance the total efficiency of power transmission with the ferrite material painted or vapor-depositioned on predetermined positions.

While preferred embodiments of the present invention have been described in this specification, it is to be understood that the invention is illustrative and not restrictive, because various changes are possible within the spirit and indispensable features.

What is claimed is:

1. A transformer comprising a multilayer construction composed of plural spiral primary-side coils of thin plate and plural spiral secondary-side coils of thin plate layered in turn, in which the primary-side coils are connected each other, the secondary-side coils are connected each other, an upper shielding layer of thin plate is disposed on an uppermost layer of the multilayer construction, and a lower shielding layer is disposed under a lowermost layer of the multilayer construction.

2. The transformer as set forth in claim 1, wherein ferrite material is disposed on the upper shielding layer, the lower shielding layer, a peripheral side portion of the multilayer construction, and inner peripheral portions of the primary-side coils and the secondary-side coils of the multilayer construction.
